(19) United States
(12) Patent Application Publication
(10) Pub. No.: US 2018/0094626 A1
(43) Pub. Date: Apr. 5, 2018

(54) COMPRESSOR DRIVING MOTOR AND COOLING METHOD FOR SAME

(71) Applicant: MITSUBISHI HEAVY INDUSTRIES THERMAL SYSTEMS, LTD., Tokyo (JP)

(72) Inventors: Naoki KOBAYASHI, Tokyo (JP); Kenji UEDA, Tokyo (JP); Yasushi HASEGAWA, Tokyo (JP); Noriyuki MATSUKURA, Tokyo (JP); Shintaro OMURA, Tokyo (JP)

(73) Assignee: MITSUBISHI HEAVY INDUSTRIES THERMAL SYSTEMS, LTD., Tokyo (JP)

(21) Appl. No.: 15/559,248

(22) PCT Filed: Mar. 8, 2016
(86) PCT No.: PCT/JP2016/001238

§ 371 Date: Sep. 18, 2017

(30) Foreign Application Priority Data
Mar. 19, 2015 (JP) 2015-055553

(51) Int. Cl. F04B 39/06; F04D 29/58; F04D 29/28; F25B 1/053; H02K 9/19

(52) U.S. Cl. CPC F04B 39/062; F04D 29/5846; H02K 9/19; F25B 1/053; F04D 29/284

(57) ABSTRACT

A compressor driving motor includes: a rotor; a stator surrounding an outer peripheral part of the rotor; a case accommodating the rotor and the stator; a liquid introduction portion introducing a liquid refrigerant from a refrigerant circuit including the compressor into the case; a gas introduction portion introducing a gas refrigerant from the refrigerant circuit into the case; and an injector using, as driving fluid, the gas refrigerant introduced by the gas introduction portion, and using, as suction fluid, the liquid refrigerant introduced by the liquid introduction portion. Wet steam of a mixture of the liquid refrigerant and the gas refrigerant mixed by the injector is injected toward at least a gap between the outer peripheral part of the rotor and an inner peripheral part of the stator.

### TECHNICAL FIELD

The present invention relates to a motor that drives a compressor, and to a cooling method for the motor.

### BACKGROUND ART

There is a method in which a portion of a refrigerant flowing through a refrigerant circuit is supplied to cool a motor that drives a compressor of a refrigerator (for example, Patent Literature 1). In Patent Literature 1, the refrigerant is introduced into a gap between a rotor and a stator to cool the motor.

### CITATION LIST

### Patent Literature

Patent Literature 1

Japanese Patent Laid-Open No. 2002-138962

### SUMMARY OF INVENTION

### Technical Problem

When heat loss of the motor is increased, an amount of refrigerant necessary for cooling is increased. Using a liquid refrigerant allows for use of latent heat, which makes it possible to efficiently perform cooling; however, an amount of the liquid refrigerant supplied to the gap is desirably small because the liquid refrigerant has large friction resistance.

Therefore, an object of the present invention is to provide a compressor driving motor that can be cooled by supplying only a minimum necessary amount of a liquid refrigerant to a gap between a rotor and a stator, and a cooling method for the compressor driving motor.

### Solution to Problem

A compressor driving motor according to the present invention includes: a rotor; a stator that surrounds an outer peripheral part of the rotor; a case that accommodates the rotor and the stator; a liquid introduction portion that introduces a liquid refrigerant from a refrigerant circuit including the compressor into the case; a gas introduction portion that introduces a gas refrigerant from the refrigerant circuit into the case; and an injector that uses, as driving fluid, the gas refrigerant introduced by the gas introduction portion, and uses, as suction fluid, the liquid refrigerant introduced by the liquid introduction portion.

Further, in the present invention, wet steam of a mixture of the liquid refrigerant and the gas refrigerant mixed by the injector is injected toward at least a gap between the outer peripheral part of the rotor and an inner peripheral part of the stator.

In the compressor driving motor according to the present invention, the injector may preferably include an injection port through which the wet steam is injected, and the injection port may preferably face an opening of the gap opened in an axis line direction of the rotor.

In the compressor driving motor according to the present invention, the injector may preferably include an injector conduit and a liquid flow path. The injector conduit receives the gas refrigerant from the gas introduction portion to merge the gas refrigerant with the liquid refrigerant. The liquid flow path causes the liquid refrigerant introduced by the liquid introduction portion to flow into the injector conduit. The injector conduit may preferably extends in parallel to an axis line of the rotor at a position facing the gap, and the liquid flow path may preferably extends in a direction orthogonal to the axis line to join the injector conduit.

In the compressor driving motor according to the present invention, the injector may preferably suck the liquid refrigerant from a liquid reservoir in the case in which the introduced liquid refrigerant is collected.

In the compressor driving motor according to the present invention, two or more injectors that are different in position of the injection port in a circumferential direction of the gap from one another may be preferably provided.

In the compressor driving motor according to the present invention, the wet steam of the mixture of the liquid refrigerant and the gas refrigerant mixed by the injector may be preferably injected also toward a clearance between an outer peripheral part of the stator and the inner peripheral part of the case.

The compressor driving motor according to the present invention is suitable to drive a centrifugal compressor including an impeller.

A refrigerant circuit according to the present invention includes the above-described compressor driving motor, the compressor, a condenser, an evaporator, and a decompression section.

Here, it is possible to distribute the gas refrigerant from discharge side of the compressor in the refrigerant circuit into the gas introduction portion, and to distribute the liquid refrigerant from downstream of the condenser in the refrigerant circuit into the liquid introduction portion. This makes it possible to obtain pressure difference to convey the gas refrigerant and the liquid refrigerant to the motor without using external power such as a pump.

In addition, according to the present invention, there is provided a cooling method for a compressor driving motor. The compressor driving motor includes a rotor, a stator, and a case, and drives a compressor. The stator surrounds an outer peripheral part of the rotor in a radial direction. The case accommodates the rotor and the stator. The method includes: a step of mixing a gas refrigerant introduced from a refrigerant circuit that includes the compressor and a liquid refrigerant introduced from the refrigerant circuit by an injector that uses the gas refrigerant as driving fluid and uses the liquid refrigerant as suction fluid; and a step of injecting wet steam of a mixture of the gas refrigerant and the liquid refrigerant, toward at least a gap between the outer peripheral part of the rotor and an inner peripheral part of the stator.

### Advantageous Effects of the Invention

According to the present invention, the wet steam of the mixture of the liquid refrigerant and the gas refrigerant that are respectively introduced from the liquid introduction portion and the gas introduction portion and mixed by the injector, is blown into the gap between the stator and the rotor. As a result, the liquid refrigerant sufficiently flows while being conveyed by the gas refrigerant. This makes it possible to reliably cool the compressor driving motor by the necessary amount of the refrigerant while reducing windage loss.

### BRIEF DESCRIPTION OF DRAWINGS

FIG. 1 is a schematic diagram illustrating a compressor driving motor according to an embodiment of the present invention, and a refrigerant circuit that includes a compressor driven by the motor.

FIG. 2A is a diagram illustrating a necessary amount of a refrigerant with respect to wetness of the refrigerant, FIG. 2B is a diagram illustrating windage loss of the motor with respect to the wetness of the refrigerant, and FIG. 2C is a diagram illustrating total loss of the motor, in which the wetness of the refrigerant indicates a rate of liquid, and “1” indicates an entirely liquid phase state.

FIGS. 3A and 3B are diagrams each illustrating the motor in a direction from an arrow III in FIG. 1.

FIG. 4 is a schematic diagram illustrating a compressor driving motor according to a modification of the present invention and a refrigerant circuit that includes a compressor driven by the motor.

### DESCRIPTION OF EMBODIMENT

An embodiment of the present invention is described below with reference to accompanying drawings.

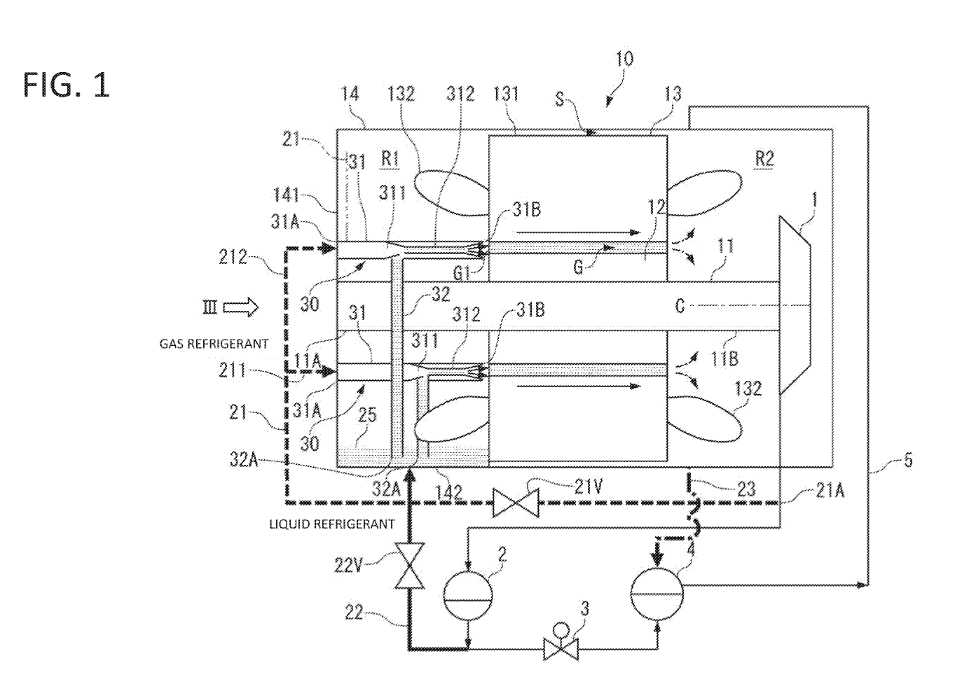

A compressor 1 illustrated in FIG. 1 configures a refrigerant circuit 5, together with a condenser 2, an expansion valve 3, an evaporator 4, and a flow path (illustrated by a thin solid line in FIG. 1) connecting them. The refrigerant circuit 5 is used in a large refrigerator installed in large-scale buildings, facilities, and the like.

The compressor 1 according to the present embodiment is a centrifugal compressor (a turbo compressor) that includes an unillustrated impeller and compress a refrigerant.

A compressor driving motor 10 (hereinafter, referred to as the motor 10) transfers rotational driving force of a shaft 11 to drive the compressor 1.

The motor 10 includes the shaft 11, a rotor 12, a stator 13, and a case 14. The rotor 12 is coupled around the shaft 11. The stator 13 surrounds an outer peripheral part of the rotor 12 in a radial direction. The case 14 accommodates the rotor 12, the stator 13, and the compressor 1. The motor 10 is disposed in posture in which the shaft 11 horizontally extends. An end of a coil (a coil end 132) projects from a core 131 of the stator 13 to each of sides in the axial direction.

The case 14 is a housing common to the motor 10 and the compressor 1. The refrigerant introduced into the case 14 is sucked and compressed by the compressor 1, and the compressed refrigerant is then discharged to the flow path of the refrigerant circuit 5.

The compressed refrigerant discharged from the compressor 1 is sucked into the compressor 1 again through the condenser 2, the expansion valve 3, and the evaporator 4.

When the coil provided in the stator 13 is energized, the rotor 12 rotates with the shaft 11 with respect to the stator 13, which causes the impeller of the compressor 1 to rotate. Rotation of the impeller causes the refrigerant in the case 14 to be sucked into the impeller.

The inside of the case 14 is divided into a rear chamber R1 and a front chamber R2 with the rotor 12 and the stator 13 in between.

The rear chamber R1 is located on rear end 11A side of the shaft 11, and communicates with the front chamber R2 through a gap G between the outer peripheral part of the rotor 12 and an inner peripheral part of the stator 13. The gap G is provided over the entire circumference of the rotor 12 and the stator 13.

The front chamber R2 is located on front end 11B side of the shaft 11, and the compressor 1 is disposed therein.

The motor 10 generates heat during operation. To ensure operation of the motor 10 and to reduce loss (heat loss) of the motor 10 due to heat generation, it is necessary to sufficiently cool the motor 10.

Therefore, a portion of the refrigerant flowing through the refrigerant circuit 5 is supplied as a cooling refrigerant to the motor 10.

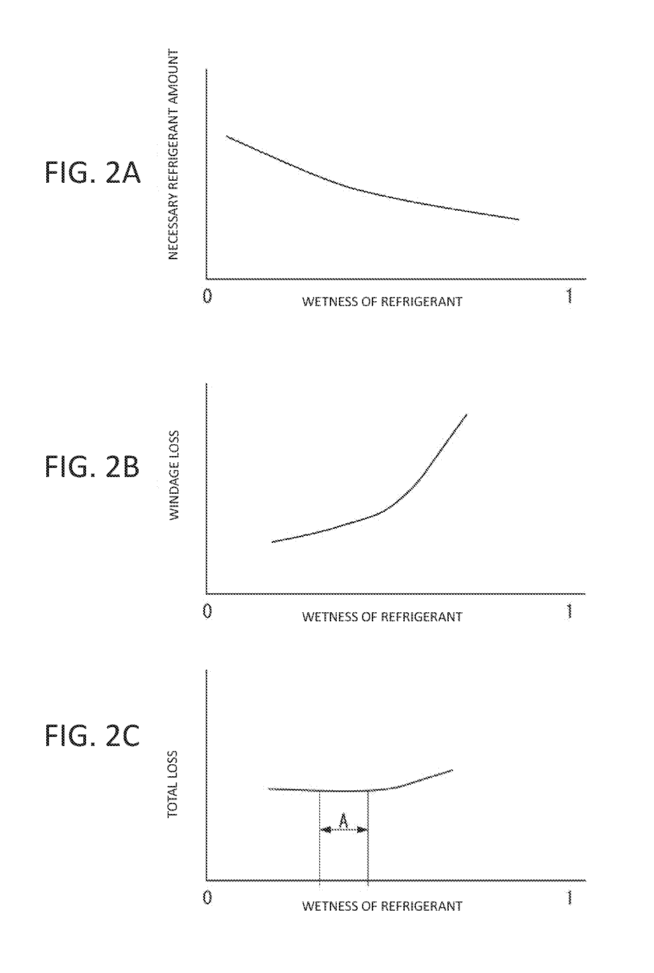

Here, wetness of the refrigerant (the rate of liquid) influences cooling efficiency. A quantity of heat absorbed by latent heat associated with phase transition from liquid phase to gas phase is larger as the wetness of the refrigerant at a fixed weight is higher. Therefore, as illustrated in FIG. 2A, an amount of refrigerant (weight base) necessary to sufficiently cool the motor 10 is smaller as the wetness of the refrigerant is higher. In other words, an amount of the refrigerant extracted from the refrigerant circuit 5 to cool the motor 10 becomes smaller as the wetness of the refrigerant is higher.

On the other hand, the wetness of the refrigerant influences windage loss of the motor 10. Frictional resistance is increased as the wetness of the refrigerant (the rate of liquid) flowing through the gap G is higher. Therefore, the windage loss is large as illustrated in FIG. 2B. When the windage loss is large, the necessary amount of the refrigerant is increased.

In addition to the windage loss, it is necessary to consider loss (bleeding loss) that is decrease of a circulation amount of the refrigerant in the refrigerant circuit 5 by the amount of the refrigerant extracted from the refrigerant circuit 5 to cool the motor 10.

Total loss in FIG. 2C indicates total of the windage loss, the bleeding loss, and loss specific to the motor 10 (copper loss and iron loss). The loss specific to the motor 10 does not depend on the wetness of the refrigerant. The windage loss becomes larger as the wetness of the refrigerant is higher. In contrast, the bleeding loss becomes smaller as the wetness of the refrigerant is higher. Note that the total loss illustrated in FIG. 2C is merely an example.

A necessary amount of the refrigerant having appropriate wetness may be preferably supplied to the rotor 12 and the stator 13 such that the total loss reflecting the windage loss and the bleeding loss both depending on the wetness of the refrigerant, becomes small.

To sufficiently cool the motor 10, the motor 10 according to the present embodiment includes: a gas introduction path 21 through which a gas refrigerant is introduced from downstream of the compressor 1 into the rear chamber R1; a liquid introduction path 22 through which a liquid refrigerant is introduced from downstream of the condenser 2 into the rear chamber R1; and a liquid discharge path 23 through which the liquid refrigerant is discharged from the front chamber R2 to the refrigerant circuit 5.

In FIG. 1, the gas introduction path 21 is illustrated by a thick dashed line, the liquid introduction path 22 is illustrated by a thick solid line, and the liquid discharge path 23 is illustrated by a thick alternate long and short dash line.

A start end part 21A of the gas introduction path 21 is connected to the middle of the flow path of the refrigerant circuit 5 through which the vapor-phase refrigerant discharged by the compressor 1 flows toward the condenser 2. As a result, a portion of the gas refrigerant discharged by the compressor 1 is distributed into the gas introduction path 21, and is introduced into the motor 10 through the gas introduction path 21.

The gas introduction path 21 is branched into a path 211 and a path 212 on the upstream of the motor 10. Both of the path 211 and the path 212 communicate with the rear chamber R1 through a side wall 141 of the case 14.

A valve 21V is provided in the gas introduction path 21. A flow rate of the gas refrigerant that is introduced into the rear chamber R1 through a termination part of each of the paths 211 and 212 of the gas introduction path 21 is set to a predetermined value by the valve 21V. As the valve 21V, an on-off valve or a flow regulating valve may be used. The valve 21V and a fixed throttle may be used together.

Note that the flow rate of the gas refrigerant introduced into the rear chamber R1 may be set to the predetermined value through setting of a diameter of the gas introduction path 21 or the like, without the valve 21V.

Opening of the valve 21V may be adjusted depending on pressure condition of the refrigerant circuit 5 and the like.

The above description relating to the valve 21V is also applied to a valve 22V described later.

The liquid introduction path 22 is arranged from the condenser 2 to the motor 10, and a portion of the liquid refrigerant flowing out from the condenser 2 is distributed from the main stream of the refrigerant circuit 5.

The liquid introduction path 22 communicates with the rear chamber R1 through a bottom part 142 of the case 14.

The liquid refrigerant introduced into the rear chamber R1 through the liquid introduction path 22 forms a liquid reservoir 25 on the bottom part 142.

The liquid introduction path 22 includes the valve 22V that sets the flow rate of the liquid refrigerant introduced into the case 14 through a termination part of the liquid introduction path 22.

The liquid discharge path 23 is arranged from a bottom part of the front chamber R2 to the evaporator 4.

Incidentally, main feature of the present embodiment is mixing of the liquid refrigerant and the gas refrigerant with use of an injector 30, and injecting of wet steam of the mixture to at least the gap G of the motor 10. The injector 30 is a type of jet pump that conveys fluid by pressure of the fluid without using power. This sufficiently cools the motor 10 by the necessary amount of the refrigerant while suppressing windage loss.

A configuration of the injector 30 that is provided in the rear chamber R1 of the motor 10 is described below.

The injector 30 functions when using, as driving fluid, the gas refrigerant introduced through the gas introduction path 21 and using, as suction fluid, the liquid refrigerant introduced through the liquid introduction path 22.

In the present embodiment, two injectors 30 are provided in order to inject the wet steam of the refrigerant toward two positions in an annular opening G1 of the gap G that opens in a direction of an axis line C of the shaft 11. The wet steam of the refrigerant is blown, by the two injectors 30, into the gap G through the two positions distanced from each other.

Each of the two injectors 30 includes an injector conduit 31 and a liquid conduit 32. The injector conduit 31 receives the gas refrigerant from the gas introduction path 21 and merges the gas refrigerant with the liquid refrigerant. The liquid conduit 32 causes the liquid refrigerant to flow into the injector conduit 31.

The injector conduit 31 horizontally extends at a position facing a predetermined position on a circumference of the gap G and is parallel to the axis line C of the shaft 11. The gas introduction path 21 (the path 211 or 212) is connected to a rear end 31A of the injector conduit 31. An injection port 31B that is located at a front end of the injector conduit 31 faces an opening G1 of the gap G.

A mixing part 311 that is gradually decreased in diameter and a conveying part 312 that conveys the flow from the mixing part 311 to the injection port 31B are provided inside the injector conduit 31.

The gas refrigerant is not necessarily introduced into the injector conduit 31 from the rear end 31A, and for example, the gas refrigerant may be introduced into the injector conduit 31 through the gas introduction path 21 (illustrated by an alternate long and two short dashes line in FIG. 1) that is provided in a direction orthogonal to the axis line of the injector conduit 31.

The liquid conduit 32 is erected from the bottom part 142 and is connected to the mixing part 311 in a direction orthogonal to the injector conduit 31. A bottom end 32A of the liquid conduit 32 is immersed in the liquid reservoir 25.

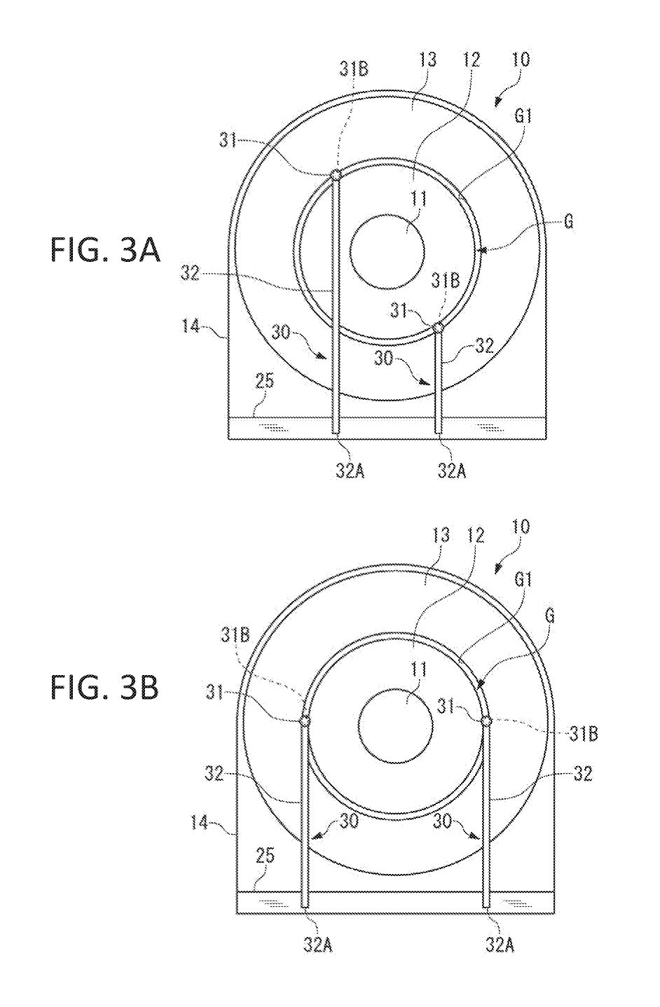

In the present embodiment, as illustrated in FIG. 3A, the injection ports 31B of the respective two injectors 30 are located at the two positions that are separated by 180 degrees from each other on the circumference of the opening G1 of the gap G. In the present embodiment, heights of these injection ports 31B are different from each other; however, these injection ports 31B may be provided at the same height as illustrated in FIG. 3B.

Note that three or more injectors 30 may be provided. The injection ports 31B of the respective injectors 30 may be preferably disposed substantially uniformly in the circumferential direction of the gap G so as to averagely supply the refrigerant over the entire circumference of the gap G.

The jet flow of the gas refrigerant that has been introduced into the injector conduit 31 through the gas introduction path 21 is further accelerated by being throttled by the mixing part 311 that is decreased in diameter. Therefore, the liquid refrigerant in the liquid reservoir 25 is sucked, through the liquid conduit 32, toward the mixing part 311 reduced in pressure and is merged with the flow of the gas refrigerant, and the direction of the flow of the liquid refrigerant is changed to the direction of the injector conduit 31. In the present embodiment, since the liquid refrigerant is sucked from the liquid reservoir that communicates with the liquid conduit 32, it is possible to continuously supply the liquid refrigerant to the motor 10. The gas refrigerant is merged with the liquid refrigerant that is larger in motion energy than the gas due to density difference, which results in a mixture of the liquid refrigerant and the gas refrigerant (mixing step).

The gas refrigerant is condensed when being mixed with the liquid refrigerant. Further, the wet steam is injected from the injection port 31B toward the opening G1 of the gap G while the pressure of the refrigerant is increased through increase of the diameter of the conveying part 312 at the terminal end (injecting step). The wet steam smoothly and sufficiently flows through the gap G, which cools the rotor 12 and the stator 13.

The flowage in the case 14 caused by suction and compression of the compressor 1 prompts the flow of the wet steam in the gap G, in addition to the injection from the injectors 30.

As described above, the portion of the liquid refrigerant used for cooling of the motor 10 is gasified and sucked into the compressor 1. An unillustrated partition is provided between the motor 10 and the impeller of the compressor 1 in the front chamber R2. Therefore, all the remaining liquid refrigerant that is not gasified is discharged through the liquid discharge path 23 without being sucked into the impeller, and flows into the evaporator 4.

According to the present embodiment, providing the injectors 30 at the respective positions each facing the gap G causes the wet steam injected from the injectors 30 to be blown into the gap G. As a result, it is possible to reliably supply the refrigerant containing the liquid refrigerant to the gap G that is small in projected area in the axis line C direction and to perform cooling.

In addition, it is possible to sufficiently cool the motor 10 by appropriately setting the flow rate of each of the gas refrigerant and the liquid refrigerant to be introduced into the injectors 30, for example, through adjustment of openings of the respective valves 21V and 22V, and supplying a necessary amount of the refrigerant having wetness that conforms to suppression of windage loss. The flow rate of each of the gas refrigerant and the liquid refrigerant to be introduced may be preferably determined so as to achieve an appropriate wetness range A that corresponds to the smallest range of the total loss of the motor 10 including the windage loss and the bleeding loss, as illustrated in FIG. 2C.

### [Modification of Present Invention]

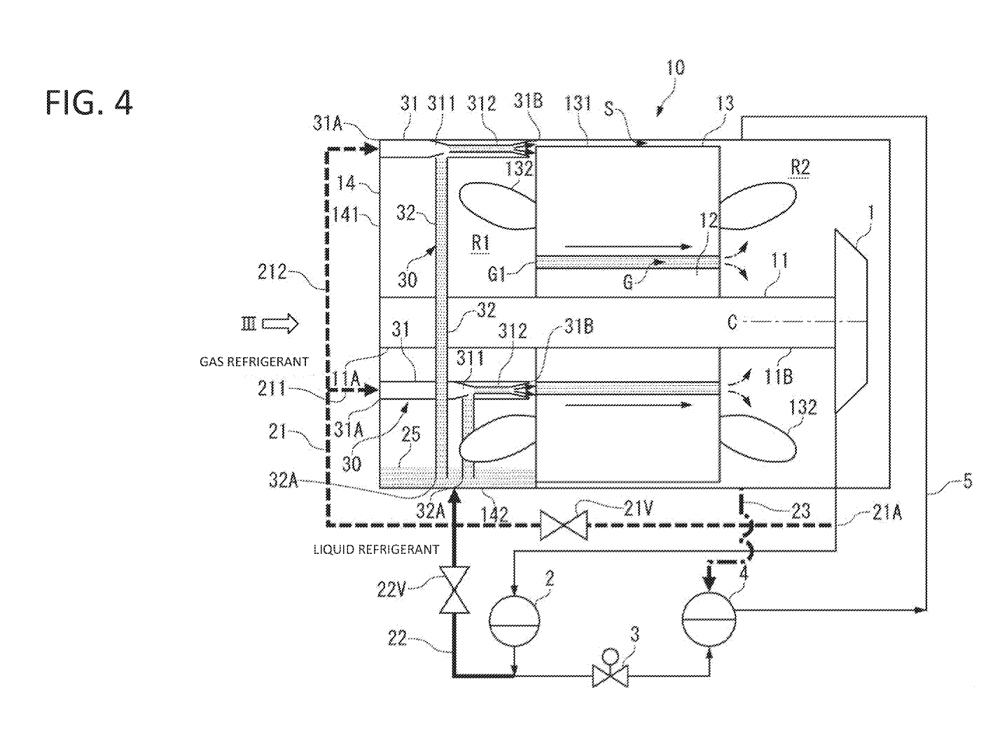

As illustrated in FIG. 4, the injector conduit 31 may be disposed at a position corresponding to a clearance S between an outer peripheral part of the stator 13 and the case 14 such that the injector 30 injects the wet steam of the refrigerant toward the clearance S. In the present modification, one injector 30 that injects the wet steam of the refrigerant toward the gap G and one injector 30 that injects the wet steam of the refrigerant toward the clearance S are provided.

A plurality of injectors 30 that correspond to a plurality of positions in the circumferential direction of the clearance S annularly formed may be provided.

In addition, the injector 30 that injects the wet steam of the refrigerant to a position requiring cooling in the motor 10, such as the coil end 132 and the shaft 11, may be provided.

The direction in which the injector conduit 31 extends may intersect the axis line C.

Other than the above, the configurations described in the above-described embodiment may be selected or may be appropriately modified without departing from the scope of the present invention.

In the above-described embodiment, the motor 10 and the compressor 1 are coaxially configured by the same shaft 11; however, the motor 10 and the compressor 1 may separately have a shaft and the shaft of the motor 10 and the shaft of the compressor 1 may be coupled to each other. A gear shifter or the like may be interposed between the shaft of the motor 10 and the shaft of the compressor 1.

In addition, in the above-described embodiment, the rotor 12 and the stator 13 of the motor 10 and the compressor 1 are accommodated in the same case 14; however, the compressor 1 may not be accommodated in the case 14. In such a case, the inside of the case 14 communicates with the suction portion (such as an outer peripheral part of the impeller) of the compressor 1 through the predetermined flow path, and flow is caused in the case 14 by suction of the compressor 1.

The direction of the shaft 11 of the motor according to the present invention is not limited, and the shaft 11 may be disposed along, for example, a vertical direction.

The compressor driven by the motor according to the present invention is not limited to the centrifugal compressor, and may be, for example, a scroll compressor or a rotary compressor.

Further, the injector 30 may be disposed in the front chamber R2 and the wet steam of the refrigerant may be blown into the gap G from the front side.

### REFERENCE SIGNS LIST

1 Compressor
2 Condenser
3 Expansion valve (decompression section)
4 Evaporator
5 Refrigerant circuit
10 Compressor driving motor
11 Shaft
11A Rear end
11B Front end
12 Rotor
13 Stator
14 Case
21 Gas introduction path (gas introduction portion)
21A Start end part
21V Valve
22 Liquid introduction path (liquid introduction portion)
22V Valve
23 Liquid discharge path
25 Liquid reservoir
30 Injector
31 Injector conduit
31A Rear end
31B Injection port
32 Liquid conduit
32A Bottom end
131 Core
132 Coil end
141 Side wall
142 Bottom part
211, 212 Path
311 Mixing part
312 Conveying part
A Wetness range
C Axis line
G Gap
G1 Opening
R1 Rear chamber
R2 Front chamber
S Clearance

1.-11. (canceled)

12. A compressor driving motor driving a compressor, the compressor driving motor comprising:
a rotor;
a stator that surrounds an outer peripheral part of the rotor;
a case that accommodates the rotor and the stator;
a liquid introduction portion that introduces a liquid refrigerant from a refrigerant circuit into the case, the refrigerant circuit including the compressor;
a gas introduction portion that introduces a gas refrigerant from the refrigerant circuit into the case; and
an injector that uses, as driving fluid, the gas refrigerant introduced by the gas introduction portion, and uses, as suction fluid, the liquid refrigerant introduced by the liquid introduction portion, wherein
wet steam of a mixture of the liquid refrigerant and the gas refrigerant mixed by the injector is injected to at least a gap between the outer peripheral part of the rotor and an inner peripheral part of the stator.

13. The compressor driving motor according to claim 12, wherein
the injector includes an injection port through which the wet steam is injected, and
the injection port faces an opening of the gap opened in an axis line direction of the rotor.

14. The compressor driving motor according to claim 13, wherein
the injector includes an injector conduit and a liquid flow path, the injector conduit receiving the gas refrigerant from the gas introduction portion to merge the gas refrigerant with the liquid refrigerant, and the liquid flow path causing the liquid refrigerant introduced by the liquid introduction portion to flow into the injector conduit, and
the injector conduit extends in parallel to an axis line of the rotor at a position facing the gap, and
the liquid flow path extends in a direction orthogonal to the axis line to join the injector conduit.

15. The compressor driving motor according to claim 12, wherein the injector sucks the liquid refrigerant from a liquid reservoir in the case in which the introduced liquid refrigerant is collected.

16. The compressor driving motor according to claim 12, wherein
the gas introduction portion includes a valve that sets a flow rate of the gas refrigerant to be introduced into the case, and
the liquid introduction portion includes a valve that sets a flow rate of the liquid refrigerant to be introduced into the case.

17. The compressor driving motor according to claim 13, wherein two or more injectors that are different in position of the injection port in a circumferential direction of the gap from one another are provided.

18. The compressor driving motor according to claim 12, wherein the wet steam of the mixture of the liquid refrigerant and the gas refrigerant mixed by the injector is injected also toward a clearance between an outer peripheral part of the stator and an inner peripheral part of the case.

19. The compressor driving motor according to claim 12, wherein the compressor is a centrifugal compressor including an impeller.

20. The compressor driving motor according to claim 12, wherein the injector is disposed in an internal space of the case.

21. A refrigerant circuit, comprising:
the compressor driving motor according to claim 12;
the compressor;
a condenser;
an evaporator; and
a decompression section.

22. A cooling method for a compressor driving motor, the compressor driving motor including a rotor, a stator, and a case, and driving a compressor, the stator surrounding an outer peripheral part of the rotor in a radial direction, the case accommodating the rotor and the stator, the method comprising:
a step of mixing, by an injector, a gas refrigerant introduced from a refrigerant circuit and a liquid refrigerant introduced from the refrigerant circuit, the injector using the gas refrigerant as driving fluid and using the liquid refrigerant as suction fluid, and the refrigerant circuit including the compressor; and
a step of injecting wet steam of a mixture of the gas refrigerant and the liquid refrigerant, toward at least a gap between the outer peripheral part of the rotor and an inner peripheral part of the stator.
